(19) United States
(12) Patent Application Publication
(10) Pub. No.: US 2017/0282057 A1
(43) Pub. Date: Oct. 5, 2017

(54) METHOD AND ELECTRONIC DEVICE FOR DETERMINING HOMING POSITION OF GAME GUN ON DISPLAY SCREEN

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Xuan Shi, Tianjin (CN)

(21) Appl. No.: 15/225,655

(22) Filed: Aug. 1, 2016

Related U.S. Application Data
(63) Continuation of application No. PCT/CN2016/088680, filed on Jul. 5, 2016.

(30) Foreign Application Priority Data
Mar. 30, 2016 (CN) 201610193202.1

(51) Int. Cl. A63F 13/219; A63F 13/837; A63F 13/25

(52) U.S. Cl. CPC A63F 13/219; A63F 13/25; A63F 13/837; A63F 2300/8076; A63F 2300/1087

(57) ABSTRACT

Disclosed are a method and an electronic device for determining a homing position of a game gun on a display screen. The method includes: when detecting that a binocular camera accesses, a multicolor filter in the binocular camera is controlled to change colors, the binocular camera is controlled to acquire images of different colors of light spots on a screen of a display screen; identifier information of a plurality of current game guns corresponding to the light spots in the acquired images are determined; and homing positions of the plurality of current game guns on the screen are respectively determined according to the acquired images of the light spots, parameters of the binocular camera, a screen display parameter of the screen and position information between the camera and the plurality of current game guns.

### CROSS REFERENCE TO RELATED APPLICATIONS

This application is a continuation of International Application No. PCT/CN2016/088680, filed on Jul. 5, 2016, which claims priority to Chinese Patent Application No. 201610193202.1, titled “METHOD AND APPARATUS FOR DETERMINING HOMING POSITION OF GAME GUN ON DISPLAY SCREEN”, filed on Mar. 30, 2016, the entire contents of which are incorporated herein by reference.

### TECHNICAL FIELD

The disclosure belongs to the technical field of electronics, and particularly relates to a method and an electronic device for determining a homing position of a game gun on a display screen.

### BACKGROUND

The inventor has found a shooter game (STG for short) in a process of implementing the disclosure. It belongs to one of game types, and also one of action games. The shooter games have an obvious feature of the action games, which have to home on a target in a game on a screen of a display by a game gun emitting light source to realize “shooting”. The display refers to a television, a computer or a smart liquid crystal display (LCD) or a light emitting diode (LED) display of other smart display.

In the prior art, a binocular camera is combined with a game gun with a plurality of luminescent light sources, and parameters of a screen are combined to serve as distance positioning between the game gun and the camera and orientation directions of the game gun to the screen. During the realization of the present invention, the inventor found that there are at least questions existed as following: since the binocular camera is used for recognizing a shape of a light emitting spot of a fixed luminescent light source, positioning a plurality of game guns with light sources by the same set of binocular camera is impossible, that is, one set of binocular camera and a reality device only determine a homing position of a game light gun, without recognizing and positioning a plurality of game guns.

### SUMMARY

The disclosure provides a method and an electronic device for determining a homing position of a game gun on a display screen, which are used for additionally providing a multicolor filter capable of filtering multiple light colors to a binocular camera, such that the binocular camera may recognize multiple game guns with different colors of light sources by the multicolor filter, and therefore the problem that homing positions of a plurality of game guns on a display screen can not be recognized in the prior art is solved.

An embodiment of the disclosure provides a method for determining a homing position of a game gun on a display screen, which is applied to a display of a smart device, including:

when detecting that a binocular camera accesses, a multicolor filter in the binocular camera is controlled to change colors in accordance with a preset switching rule, and the binocular camera is controlled to acquire images of different colors of light spots on a screen of a display screen through the multicolor filter in a time-sharing manner, wherein different colors of the light spots are emitted by different game guns; identifier information of a plurality of current game guns corresponding to the light spots in the acquired images are determined according to preset colors and shapes of the light spots of the game guns; and homing positions of the plurality of current game guns on the screen are respectively determined according to the acquired images of the light spots and a preset positioning algorithm.

The embodiment of the disclosure provides an electronic device for determining a homing position of a game gun on a display screen, including:

one or more processors; and

a memory; wherein,

the memory is stored with instructions executable by the one or more processors, the instructions are configured to:

when detecting that a binocular camera accesses, a multicolor filter in the binocular camera is controlled to change colors in accordance with a preset switching rule, and the binocular camera is controlled to acquire images of different colors of light spots on a screen of a display screen through the multicolor filter in a time-sharing manner, wherein different colors of the light spots are emitted by different game guns;

identifier information of a plurality of current game guns corresponding to the light spots in the acquired images are determined according to preset colors and shapes of the light spots of the game guns;

and homing positions of the plurality of current game guns on the screen are respectively determined according to the acquired images of the light spots and a preset positioning algorithm.

The embodiment of the disclosure provides a nonvolatile computer storage media, which has computer executable instructions stored thereon, wherein the computer executable instructions are configured to:

when detecting that a binocular camera accesses, a multicolor filter in the binocular camera is controlled to change colors in accordance with a preset switching rule, and the binocular camera is controlled to acquire images of different colors of light spots on a screen of a display screen through the multicolor filter in a time-sharing manner, wherein different colors of the light spots are emitted by different game guns;

identifier information of a plurality of current game guns corresponding to the light spots in the acquired images are determined according to preset colors and shapes of the light spots of the game guns;

and homing positions of the plurality of current game guns on the screen are respectively determined according to the acquired images of the light spots and a preset positioning algorithm.

It may be known from the above embodiment of the disclosure that, according to the method and the electronic device for determining the homing position of the game gun on the display screen, which are provided by the disclosure, a multicolor filter capable of filtering multiple light colors is additionally provided to the binocular camera, and the color changing of the multicolor filter is controlled, such that the binocular camera may recognize multiple game guns with different colors of light sources by the multicolor filter, so as to determine homing positions of more game guns on the display screen, thus the accuracy of determining the homing positions is improved, the number of the game guns participating in a game is increased, and that a plurality of game guns to be simultaneously used in the game are supported by only one set of binocular camera is realized.

### BRIEF DESCRIPTION OF THE DRAWINGS

To more clearly illustrate the technical solution in the embodiments of the disclosure or in the prior art, the following will briefly introduce the accompanying drawings to be used in the description of the embodiments or the prior art. It is apparent that the accompanying drawings in the following description are merely illustrative of some embodiments of the disclosure.

FIG. 1 is a schematic diagram of an application scenario of a method for determining a homing position of a game gun on a display screen according to an embodiment of the disclosure.

FIG. 2 is a schematic diagram of an implementation process of a method for determining a homing position of a game gun on a display screen according to a first embodiment of the disclosure.

FIG. 3 is a schematic diagram of an implementation process of a method for determining a homing position of a game gun on a display screen according to a second embodiment of the disclosure.

FIG. 4 is a schematic diagram of a structure of an apparatus for determining a homing position of a game gun on a display screen according to a third embodiment of the disclosure.

FIG. 5 is a schematic diagram of a structure of an apparatus for determining a homing position of a game gun on a display screen according to a fourth embodiment of the disclosure;

FIG. 6 is a schematic diagram of a structure of an hardware of the electronic device of the method for determining a homing position of a game gun on a display screen according to a fifth embodiment of the disclosure.

### DETAILED DESCRIPTION

To make the objects, features and advantages of the disclosure be more obvious and easy to understand, the technical solution will be completely and clearly described below in conjunction with the accompanying drawings in the embodiments of the disclosure. It is apparent that the embodiments described are merely illustrative of some, but not all embodiments of the disclosure. Based on the embodiments in the disclosure, all other embodiments obtained by those skilled in the art without paying inventive efforts all belong to a protective scope of the disclosure.

The disclosure provides a method and an electronic device for determining a homing position of a game gun on a display screen, which are used for additionally providing a multicolor filter capable of filtering multiple light colors to a binocular camera, such that the binocular camera may recognize multiple game guns with different colors of light sources by the multicolor filter, and therefore the problem that homing positions of a plurality of game guns on a display screen can not be recognized in the prior art is solved.

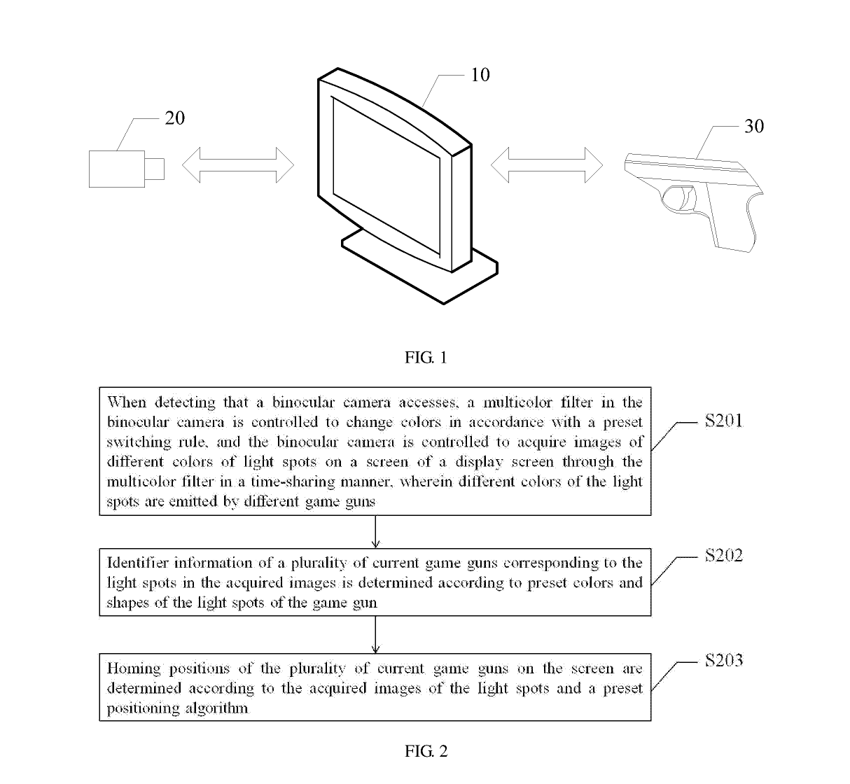

A method for determining a homing position of a game gun on a display screen, which is provided by an embodiment of the disclosure, may be applied to determination of a homing position of a game gun on a screen of a display when a shooter game is run in the display of a smart device such as a television or a computer. The display is a LCD display or LED display. With reference to FIG. 1, FIG. 1 is a schematic diagram of an application scenario of the determining method.

A binocular camera 102 is connected with the smart device 101, particularly may be connected with the smart device 101 through a USB line, or connected with the smart device 101 by means of a wireless manner or other wired connection manners besides the USB line, which is not particularly limited herein.

A shooter game module may be provided in the smart device 101, may run a shooter game, and transmits and receives data, which is related to a game, produced in a shooter game process, wherein the data includes data, which is related to a game gun 103 necessary for the shooter game, collected by the binocular camera 102. It is to be noted that, the shooter game module may be not provided in the smart device 101, but is provided in a single game machine, the shooter game is run in this game machine, the game machine is connected with the game gun, and the game machine is connected with the smart device 101 to realize that a game picture is displayed on a display screen of the smart device 101. A scenario shown in FIG. 1 is that the shooter game is run in the smart device 101, and the game gun 30 is directly connected with the smart device 101.

The game gun 30 is connected with the smart device 10 for being operated by a user to form a shooting action for a game picture on a display screen of the smart device 10.

With reference to FIG. 2, FIG. 2 is a schematic diagram of an implementation process of a method for determining a homing position of a game gun on a display screen according to a first embodiment of the disclosure. The method may be applied to individual devices shown in FIG. 1, and mainly includes the following steps:

S201: When detecting that a binocular camera accesses, a multicolor filter in the binocular camera is controlled to change colors in accordance with a preset switching rule, and the binocular camera is collected to acquire images of different colors of light spots on a screen of a display screen through the multicolor filter wherein different colors of the light spots are emitted by different game guns.

The binocular camera includes two cameras, the two cameras may be depth cameras (that is, 3D sensing cameras), and to conveniently process the acquired images, the two cameras usually have the same parameters.

In the binocular camera, a multicolor filter and a multicolor filter switcher are provided. The multicolor filter is particularly an electrified filter, and the multicolor filter may be switched into different colors to filter different colors under the control of a switcher control panel.

The switching rule specifies that the multicolor filter is switched into different colors according to the specified switching frequency and the specified color order, such that light a color of which is identical to a current color of the multicolor filter passes. For example, the multicolor filter is a red, yellow and blue three-color filter. The switching rule specifies that the multicolor filter is switched in the color order of red-yellow-blue in accordance with the switching frequency of 60 times/second, the multicolor filter is controlled to start from red light, and sequentially switched into a red filter, a yellow filter and a blue filter in accordance with the frequency of 60 times/second, and cyclically switched according to this rule.

The smart device controls the binocular camera to acquire the image of the screen, the binocular camera acquires images of different colors of light spots on the screen of the display screen through the multicolor filter, and the light spots are formed by light emitted by light sources in the game guns on the screen of the display. When the multicolor filter is the red filter, an image of a red light spot is only acquired; and when the multicolor filter is the blue filter, an image of a blue light spot is only acquired. Different colors of the light spots are emitted from light sources disposed in different game guns. Therefore, the multicolor filter continuously acquires the images of different colors of light spots emitted by the game guns in a color changing process.

S202: Identifier information of a plurality of current game guns corresponding to the light spots in the acquired images is determined according to preset colors and shapes of the light spots of the game guns.

Information of the game gun supported by the shooter game is preset in the smart device, wherein the information includes information of the light spots formed by the light source of the game gun, and the information of the light spots particularly may include information of colors, shapes and number of the light spots formed by each game gun. Particularly, one shooter game mostly may support three game guns, the three game guns are effective within a distance 2 m from the screen, the light spots formed by the emitted light on the screen include red, yellow and blue light spots, may be identical in shapes, all being circular or square, or may also be different in shapes, respectively being circular, square and triangular.

Identifier information of a plurality of current game guns corresponding to light spots in the images acquired by the binocular camera may be determined according to preset colors and shapes of the light spots of the game guns, that is, a correspondence between the identifier information of the game guns and the light spots may be determined, for example, the red circular light spot is emitted by the game gun with an ID of 001, and the blue square light spot is emitted by the game gun with an ID of 002.

S203: Homing positions of the plurality of current game guns on the screen are determined according to the acquired images of the light spots and a preset positioning algorithm.

Particularly, homing positions of a plurality of current game guns on the screen may be respectively determined according to the acquired images of the light spots, parameters of the binocular camera, a screen display parameter of the screen as well as position information between the binocular camera and the plurality of current game guns.

The parameters of the binocular camera include a center distance between two cameras in the binocular camera and a focal length of each camera.

The screen display parameter includes display size information of the screen, including a display height and a display width of the screen, that is, a height and a width of a picture which can be displayed by the screen.

Positions between the binocular camera and each of the plurality of current game guns may be calculated by a preset algorithm. In a positioning process, two cameras of the binocular camera are in the same plane, and optical axes are mutually parallel, muzzle light-emitting positions of the game guns are set to feature points, some preprocessing algorithms, for instance, binaryzation, edge extraction, feature point denoising and the like, about images are preset for extracting and segmenting feature points in the two images simultaneously acquired by the two cameras, and thus the extraction for the feature points is completed. Further, the binocular camera respectively acquires coordinates of the feature points on the two cameras, and may obtain coordinates of the feature points in a coordinate system of one camera according to the distance between the cameras, that is, obtains a position of the game gun. The position of the game gun may be obtained by other positioning algorithms except for this, which is not limited herein. For example, after one game gun is recognized, the position of the game gun is positioned by a preset stereo matching algorithm.

Homing positions of a plurality of current game guns on the screen may be respectively determined according to the acquired images of multiple colors of the light spots, the above parameters of the binocular camera, the screen display parameter of the screen as well as the position information between the binocular camera and the plurality of current game guns.

In the embodiment of the disclosure, a multicolor filter capable of filtering multiple light colors is additionally provided to the binocular camera, and the color changing of the multicolor filter is controlled, such that the binocular camera may recognize multiple game guns with different colors of light sources by the multicolor filter, so as to determine homing positions of more game guns on the display screen, thus the accuracy of determining the homing positions is improved, the number of the game guns participating in a game is increased, and that a plurality of game guns to be simultaneously used in the game are supported by only one set of binocular camera is realized.

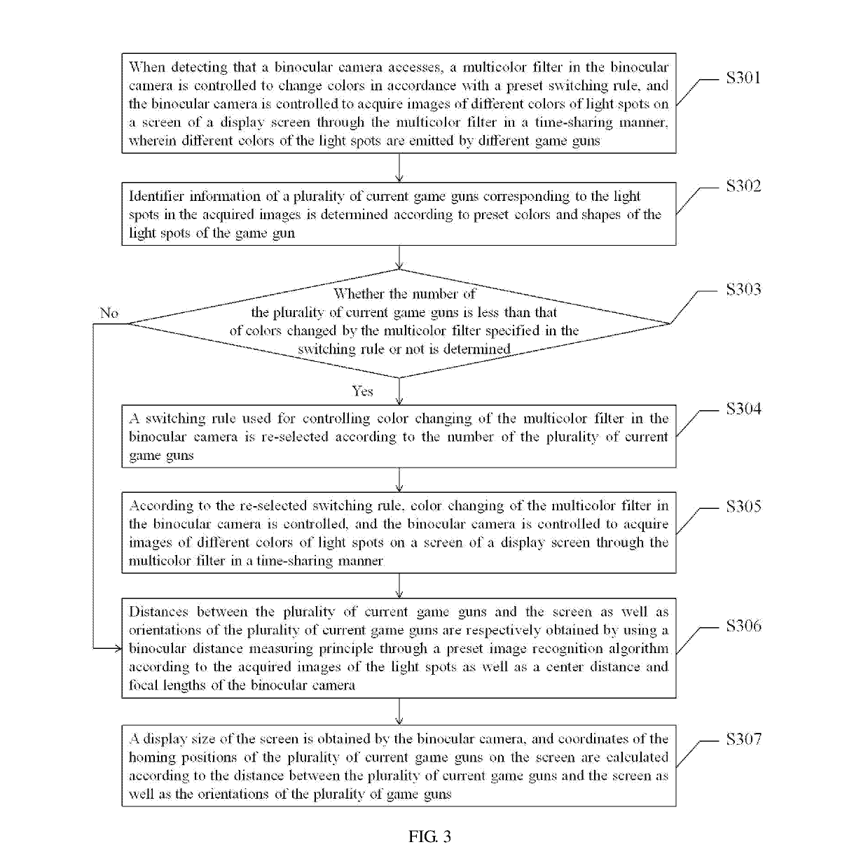

With reference to FIG. 3, FIG. 3 is a schematic diagram of an implementation process of a method for determining a homing position of a game gun on a display screen according to a second embodiment of the disclosure. The method may be applied to individual devices shown in FIG. 1, and mainly includes the following steps:

S301. When detecting that a binocular camera accesses, a multicolor filter in the binocular camera is controlled to change colors in accordance with a preset switching rule, and the binocular camera is controlled to acquire images of different colors of light spots on a screen of a display screen through the multicolor filter, wherein different colors of the light spots are emitted by different game guns.

In the binocular camera, a multicolor filter and a multicolor filter switcher are provided. The multicolor filter is particularly an electrified filter, and the multicolor filter may be switched into different colors to filter different colors under the control of a switcher control panel.

The switching rule specifies that the multicolor filter is switched into different colors according to the specified switching frequency and the specified color order, such that light a color of which is identical to a current color of the multicolor filter passes. For example, the multicolor filter is a red, yellow and blue three-color filter. The switching rule specifies that the multicolor filter is switched in the color order of red-yellow-blue in accordance with the switching frequency of 60 times/second, the multicolor filter is controlled to start from red light, and sequentially switched into a red filter, a yellow filter and a blue filter in accordance with the frequency of 60 times/second, and cyclically switched according to this rule.

The smart device controls the binocular camera to acquire the image of the screen, the binocular camera acquires images of different colors of light spots on a screen of a display screen through the multicolor filter, and the light spots are formed by light emitted by light sources in the game guns on the screen of the display. When the multicolor filter is the red filter, an image of a red light spot is only acquired; and when the multicolor filter is the blue filter, an image of a blue light spot is only acquired. Different colors of the light spots are emitted from light sources disposed in different game guns. Therefore, the multicolor filter continuously acquires the images of different colors of light spots emitted by the game gun in a color changing process.

S302. Identifier information of a plurality of current game guns corresponding to the light spots in the acquired images is determined according to preset colors and shapes of the light spots of the game guns.

Information of the game gun supported by the shooter game is preset in the smart device, wherein the information includes information of the light spots formed by the light sources of the game guns, and the information of the light spots particularly may include information of colors, shapes and number of the light spots formed by each game gun. Particularly, one shooter game mostly may support three game guns, the three game guns are effective within a distance 2 m from the screen, the light spots formed by the emitted light on the screen include red, yellow and blue light spots, may be identical in shapes, all being circular or square, or may also be different in shapes, respectively being circular, square and triangular.

Identifier information of a plurality of current game guns corresponding to light spots in the images acquired by the binocular camera may be determined according to preset colors and shapes of the light spots of the game guns, that is, a correspondence between the identifier information of the game guns and the light spots may be determined, for example, the red circular light spot is emitted by the game gun with an ID of 001, and the blue square light spot is emitted by the game gun with an ID of 002.

Further, the number and the identifier information of the game guns may be more rapidly determined according to the preset number of light spots of the game guns. When the determined number of the game guns is equal to that of the preset light spots of the game guns, the confirmation of the number and the identifier information of the game guns is stopped.

S303: Whether the number of the plurality of current game guns is less than that of colors changed by the multicolor filter specified in the switching rule or not is determined;

if yes, executing a step S304; if not, executing a step S306.

S304: A switching rule used for controlling color changing of the multicolor filter in the binocular camera is re-selected according to the number of the plurality of current game guns.

When colors of the light spots of the plurality of current game guns are less than those which may be filtered by the multicolor filter in a system, for example, the number of the current game guns is 2, the colors of the formed light spots are red and blue, but the number of the colors which may be filtered by the multicolor filter are 5, then to save time and increase speed, the colors except for the colors of the light spots of the current game guns are not filtered any more.

Therefore, there is a need for re-selecting a different switching rule, a color changing order in the re-selected switching rule changes in comparison with the switching rule in the step S301, because less light colors pass through the multicolor filter. The switching frequency in the re-selected switching rule may be equal to or different from that in the switching rule in the step S301, for example, the re-selected switching rule specifies that the switching frequency is 80 times/second, a color order switching order is red-blue, the multicolor filter is controlled to start from red light, and sequentially switched into a red filter and a blue filter in accordance with the frequency of 80 times/second, and cyclically switched according to this rule.

S305: According to the re-selected switching rule, the multicolor filter in the binocular camera is controlled to change colors, and the binocular camera is controlled to acquire images of different colors of light spots on the screen of the display screen through the multicolor filter in a time-sharing manner;

S306: Distances between the plurality of current game guns and the screen as well as orientations of the plurality of current game guns are respectively obtained by using a binocular distance measuring principle through a preset image recognition algorithm according to the acquired images of the light spots as well as a center distance and focal lengths of the binocular camera.

The parameters of the binocular camera include a center distance between two cameras in the binocular camera and a focal length of each camera.

Positions between the binocular camera and each of the plurality of current game guns may be calculated by a preset algorithm.

After the homing positions of the plurality of current game guns on the screen are respectively determined, a correspondence between the identifier information of each of the plurality of current game guns and the homing positions is sent to a game module, such that the game module runs the shooter game according to the correspondence.

Specific contents of the distances between the plurality of current game guns and the screen are respectively obtained by using a binocular distance measuring principle through a preset image recognition algorithm, and refer to contents of the step S203 in the embodiment shown in FIG. 2, which will be omitted hereinafter.

S307: A display size of the screen is obtained by the binocular camera, and coordinates of the homing positions of the plurality of current game guns on the screen are calculated according to the distances between the plurality of current game guns and the screen as well as the orientations of the plurality of game guns.

Display size information of the screen includes a display height and a display width of the screen, that is, a height and a width of a picture which can be displayed by the screen.

The display size of the screen is obtained by the binocular camera, and the coordinates of the homing positions of the plurality of current game guns on the screen are obtained according to the distances between the plurality of current game guns and the screen and the orientations of the plurality of game guns.

In the embodiment of the disclosure, a multicolor filter capable of filtering multiple light colors is additionally provided to the binocular camera, and the color changing of the multicolor filter is controlled, such that the binocular camera may recognize multiple game guns with different colors of light sources by the multicolor filter, so as to determine homing positions of more game guns on the display screen, thus the accuracy of determining the homing positions is improved, the number of the game guns participating in a game is increased, and that a plurality of game guns to be simultaneously used in the game are supported by only one set of binocular camera is realized.

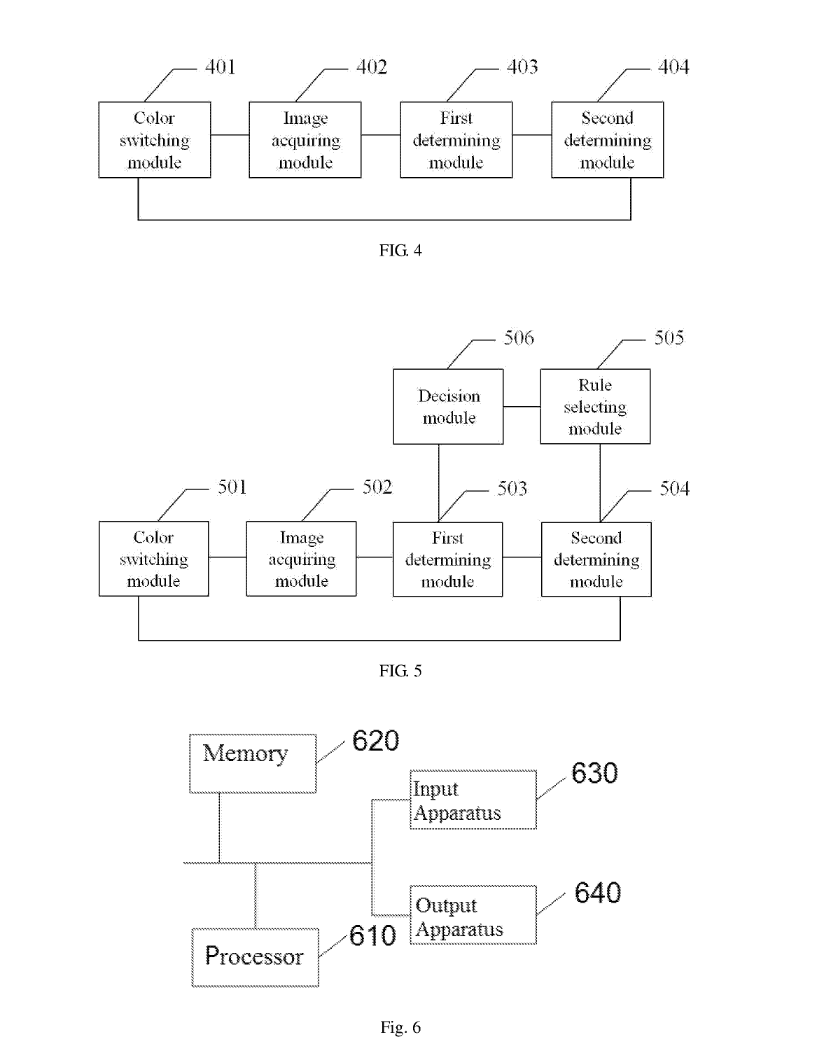

With reference to FIG. 4, FIG. 4 is a schematic diagram of a structure of an apparatus for determining a homing position of a game gun on a display screen according to a third embodiment of the disclosure. For ease of description, parts related to the embodiment of the disclosure are only shown. The apparatus, exemplified in FIG. 4, for determining a homing position of a game gun on a display screen may be an executive main body of a method for determining a homing position of a game gun on a display screen, which is provided by the previous embodiments shown in FIG. 2 and FIG. 3, and the executive main body may be a smart device or a control module in the smart device. The apparatus, exemplified in FIG. 4, for determining a homing position of a game gun on a display screen mainly includes a color switching module 401, an image acquiring module 402, a first determining module 403 and a second determining module 404. The above functional modules are described in detail as below.

The color switching module 401 is configured to, when detecting that a binocular camera accesses, control a multicolor filter in the binocular camera to change colors in accordance with a preset switching rule.

The binocular camera includes two cameras, and to conveniently process the acquired images, the two cameras usually have same parameters.

In the binocular camera, a multicolor filter and a multicolor filter switcher are provided. The multicolor filter is particularly an electrified filter, and the multicolor filter may be switched into different colors to filter different colors under the control of a switcher control panel.

The switching rule specifies that the multicolor filter is switched into different colors according to the specified switching frequency and the specified color order, such that light a color of which is identical to a current color of the multicolor filter passes. For example, the multicolor filter is a red, yellow and blue three-color filter. The switching rule specifies that the multicolor filter is switched in the color order of red-yellow-blue in accordance with the switching frequency of 60 times/second, the multicolor filter is controlled to start from red light, and sequentially switched into a red filter, a yellow filter and a blue filter in accordance with the frequency of 60 times/second, and cyclically switched according to this rule.

The image acquiring module 402 is configured to control the binocular camera to acquire images of different colors of light spots on a screen of a display screen through the multicolor filter in a time-sharing manner, wherein different colors of the light spots are emitted by different game guns.

The smart device controls the binocular camera to acquire the image of the screen, the binocular camera acquires images of different colors of light spots on a screen of a display screen through the multicolor filter, and the light spots are formed by light emitted by light sources in game guns on the screen of the display. When the multicolor filter is the red filter, an image of a red light spot is only acquired; and when the multicolor filter is the blue filter, an image of a blue light spot is only acquired. Different colors of the light spots are emitted from light sources disposed in different game guns. Therefore, the multicolor filter continuously acquires the images of different colors of light spots emitted by the game gun in a color changing process.

The first determining module 403 is configured to, according to preset colors and shapes of the light spots of the game gun, determine identifier information of a plurality of current game guns corresponding to the light spots in the acquired images.

Information of the game gun supported by the shooter game is preset in the smart device, wherein the information includes information of the light spots formed by light sources of the game guns, and the information of the light spots particularly may include information of colors, shapes and number of the light spots formed by each game gun. Particularly, one shooter game mostly may support three game guns, the three game guns are effective within a distance 2 m from the screen, the light spots formed by the emitted light on the screen include red, yellow and blue light spots, may be identical in shapes, all being circular or square, or may also be different in shapes, respectively being circular, square and triangular.

Identifier information of a plurality of current game guns corresponding to light spots in the images acquired by the binocular camera may be determined according to preset colors and shapes of the light spots of the game guns, that is, a correspondence between the identifier information of the game guns and the light spots may be determined, for example, the red circular light spot is emitted by the game gun with an ID of 001, and the blue square light spot is emitted by the game gun with an ID of 002.

The second determining module 404 is configured to, according to the acquired images of the light spots and a preset positioning algorithm, determine homing positions of the plurality of current game guns on the screen.

Particularly, homing positions of a plurality of current game guns on the screen are respectively determined according to the acquired images of the light spots, parameters of the binocular camera, a screen display parameter of the screen as well as position information between the binocular camera and the plurality of current game guns.

The parameters of the binocular camera include a center distance between two cameras in the binocular camera and a focal length of each camera.

The screen display parameter includes display size information of the screen, including a display height and a display width of the screen, that is, a height and a width of a picture which can be displayed by the screen.

A color filtering order specified in the switching rule refers to an order from a starting color of the multicolor filter capable of filtering light to an ending color of this switching.

Positions between the binocular camera and each of the plurality of current game guns may be calculated by a preset algorithm. In a positioning process, two cameras of the binocular camera are in the same plane, and optical axes are mutually parallel, muzzle light-emitting positions of the game guns are set to feature points, some preprocessing algorithms, for instance, binaryzation, edge extraction, feature point denoising and the like, about images are preset for extracting and segmenting feature points in the two images simultaneously acquired by the two cameras, and thus the extraction for the feature points is completed. Further, the binocular camera respectively acquires coordinates of the feature points on the two cameras, and may obtain coordinates of the feature points in a coordinate system of one camera according to the distance between the cameras, that is, obtains a position of the game gun. The position of the game gun may be obtained by other positioning algorithms except for this, which is not limited herein. For example, after one game gun is recognized, the position of the game gun is positioned by a preset stereo matching algorithm.

Homing positions of a plurality of current game guns on the screen may be respectively determined according to the above parameters of the binocular camera, a screen display parameter of the screen, a color filtering order specified in the switching rule as well as position information between the binocular camera and the plurality of current game guns.

Details, which are not described in detail, of this embodiment refer to the description of the previous embodiments shown in FIG. 1 to FIG. 3, which will be omitted hereinafter.

It is to be noted that, in an implementation of the apparatus, exemplified in FIG. 4, for determining a homing position of a game gun on a display screen, the division of individual functional modules is merely illustrated by way of example, the above function allocation may be completed by different functional modules in actual application as required, for example, for a configuration requirement of corresponding hardware or convenience of implementation of software, that is, an internal structure of an apparatus for determining a homing position of a game gun on a display screen is divided into different functional modules, so as to complete all or some functions described as above. Moreover, in actual application, the corresponding functional modules in this embodiment may be implemented by corresponding hardware, or may also be completed by executing corresponding software by corresponding hardware. The individual embodiments provided by the specification may be applied to the above description principle, which will be omitted hereinafter.

In the embodiment of the disclosure, a multicolor filter capable of filtering multiple light colors is additionally provided to the binocular camera, and the color changing of the multicolor filter is controlled, such that the binocular camera may recognize multiple game guns with different colors of light sources by the multicolor filter, so as to determine homing positions of more game guns on the display screen, thus the accuracy of determining the homing positions is improved, the number of the game guns participating in a game is increased, and that a plurality of game guns to be simultaneously used in the game are supported by only one set of binocular camera is realized.

With reference to FIG. 5, FIG. 5 is a schematic diagram of a structure of an apparatus for determining a homing position of a game gun on a display screen according to a fourth embodiment of the disclosure. For ease of description, parts related to the embodiment of the disclosure are only shown. The apparatus, exemplified in FIG. 5, for determining a homing position of a game gun on a display screen may be an executive main body of a method for determining a homing position of a game gun on a display screen, which is provided by the previous embodiments shown in FIG. 2 and FIG. 3, and the executive main body may be a smart device or a control module in the smart device. The apparatus, exemplified in FIG. 5, for determining a homing position of a game gun on a display screen mainly includes a color switching module 501, an image acquiring module 502, a first determining module 503, a second determining module 504, a rule selecting module 505 and a decision module 506. The above functional modules are described in detail as below.

The color switching module 501 is configured to, when detecting that a binocular camera accesses, control a multicolor filter in the binocular camera to change colors in accordance with a preset switching rule.

The binocular camera includes two cameras, and to conveniently process the acquired images, the two cameras usually have same parameters.

In the binocular camera, a multicolor filter and a multicolor filter switcher are provided. The multicolor filter is particularly an electrified filter, and the multicolor filter may be switched into different colors to filter different colors under the control of a switcher control panel.

The switching rule specifies that the multicolor filter is switched into different colors according to the specified switching frequency and the specified color order, such that light a color of which is identical to a current color of the multicolor filter passes. For example, the multicolor filter is a red, yellow and blue three-color filter. The switching rule specifies that the multicolor filter is switched in the color order of red-yellow-blue in accordance with the switching frequency of 60 times/second, the multicolor filter is controlled to start from red light, and sequentially switched into a red filter, a yellow filter and a blue filter in accordance with the frequency of 60 times/second, and cyclically switched according to this rule.

The image acquiring module 502 is configured to control the binocular camera to acquire images of different colors of light spots on a screen of a display screen through the multicolor filter in a time-sharing manner, wherein different colors of the light spots are emitted by different game guns.

The smart device controls the binocular camera to acquire an image of the screen, the binocular camera acquires images of different colors of light spots on a screen of a display screen through the multicolor filter, and the light spots are formed by light emitted by light sources in game guns on the screen of the display. When the multicolor filter is the red filter, an image of a red light spot is only acquired; and when the multicolor filter is the blue filter, an image of a blue light spot is only acquired. Different colors of the light spots are emitted from light sources disposed in different game guns. Therefore, the multicolor filter continuously acquires the images of different colors of light spots emitted by the game gun in a color changing process.

The first determining module 503 is configured to, according to preset colors and shapes of the light spots of the game gun, determine identifier information of a plurality of current game guns corresponding to the light spots in the acquired images.

Information of the game gun supported by the shooter game is preset in the smart device, wherein the information includes information of the light spots formed by light sources of the game guns, and the information of the light spot particularly may include information of colors, shapes and number of the light spots formed by each game gun. Particularly, one shooter game mostly may support three game guns, the three game guns are effective within a distance 2 m from the screen, the light spots formed by the emitted light on the screen include red, yellow and blue light spots, may be identical in shapes, all being circular or square, or may also be different in shapes, respectively being circular, square and triangular.

Identifier information of a plurality of current game guns corresponding to light spots in the images acquired by the binocular camera may be determined according to preset colors and shapes of the light spots of the game guns, that is, a correspondence between the identifier information of the game guns and the light spots may be determined, for example, the red circular light spot is emitted by the game gun with an ID of 001, and the blue square light spot is emitted by the game gun with an ID of 002.

The second determining module 504 is configured to, according to the acquired images of the light spots, parameters of the binocular camera, a screen display parameter of the screen as well as position information between the binocular camera and the plurality of current game guns, respectively determine homing positions of the plurality of current game guns on the screen.

The parameters of the binocular camera include a center distance between two cameras in the binocular camera and a focal length of each camera.

The screen display parameter includes display size information of the screen, including a display height and a display width of the screen, that is, a height and a width of a picture which can be displayed by the screen.

Positions between the binocular camera and each of the plurality of current game guns may be calculated by a preset algorithm. In a positioning process, two cameras of the binocular camera are in the same plane, and optical axes are mutually parallel, muzzle light-emitting positions of the game guns are set to feature points, some preprocessing algorithms, for instance, binaryzation, edge extraction, feature point denoising and the like, about images are preset for extracting and segmenting feature points in the two images simultaneously acquired by the two cameras, and thus the extraction for the feature points is completed. Further, the binocular camera respectively acquires coordinates of the feature points on the two cameras, and may obtain coordinates of the feature points in a coordinate system of one camera according to the distance between the cameras, that is, obtains a position of the game gun. The position of the game gun may be obtained by other positioning algorithms except for this, which is not limited herein. For example, after one game gun is recognized, the position of the game gun is positioned by a preset stereo matching algorithm.

Homing positions of a plurality of current game guns on the screen may be respectively determined according to the above parameters of the binocular camera, a screen display parameter of the screen, a color filtering order specified in the switching rule as well as position information between the binocular camera and the plurality of current game guns.

Further, the apparatus further includes a rule selecting module 505.

The rule selecting module 505 is configured to, according to the number of the plurality of current game guns, re-select a switching rule used for controlling color changing of the multicolor filter in the binocular camera.

When colors of the light spots of a plurality of current game guns are less than those which may be filtered by the multicolor filter in a system, for example, the number of the current game guns is 2, the colors of the formed light spots are red and blue, and the number of colors which may be filtered by the multicolor filter are 5, then to save time and increase speed, the colors except for the colors of the light spots of the current game guns are not filtered any more.

Therefore, there is a need for re-selecting a different switching rule, a color changing order in the re-selected switching rule changes, because less light colors pass through the multicolor filter. The switching frequency in the re-selected switching rule may be unvaried or varied, for example, the re-selected switching rule specifies that the switching frequency is 80 times/second, a color order switching order is red-blue, the multicolor filter is controlled to start from red light, and sequentially switched into a red filter and a blue filter in accordance with the frequency of 80 times/second, and cyclically switched according to this rule.

The color switching module 501 is further configured to, according to the re-selected switching rule, control color changing of the multicolor filter in the binocular camera.

The color switching module 502 is further configured to control the binocular camera to acquire images of different colors of light spots on the screen of the display screen through the multicolor filter in a time-sharing manner.

Further, the apparatus further includes:

a decision module 506, which is configured to determine whether the number of the plurality of current game guns is less than that of colors changed by the multicolor filter specified in the switching rule or not.

If a determining result is that the number of the plurality of current game guns is less than that of colors changed by the multicolor filter specified in the switching rule, the rule selecting module 505 re-selects, according to the number of the plurality of current game guns, a switching rule used for controlling color changing of the multicolor filter in the binocular camera.

Further, the second determining module 504 particularly respectively obtains distances between the plurality of current game guns and the screen as well as orientations of the plurality of current game guns by using a binocular distance measuring principle through a preset image recognition algorithm according to the acquired images of the light spots as well as a center distance and focal lengths of the binocular camera; and obtains a display size of the screen by the binocular camera, and calculates coordinates of the homing positions of the plurality of current game guns on the screen according to the distances between the plurality of current game guns and the screen as well as the orientations of the plurality of game guns.

In another aspect, if the determining result is that the number of the plurality of current game guns is equal to or greater than that of colors changed by the multicolor filter specified in the switching rule, the second determining module 504 respectively determines homing positions of the plurality of current game guns on the screen according to the parameters of the binocular camera, the screen display parameter of the screen, the color filtering order specified in the switching rule as well as position information between the binocular camera and the plurality of current game guns.

Further, the first determining module 503 is further configured to, according to preset colors and shapes of the light spots of the game gun as well as the number of the light spots, determine identifier information of a plurality of current game guns corresponding to the light spots in the acquired images.

Details, which are not described in detail, of this embodiment refer to the description of the previous embodiments shown in FIG. 1 to FIG. 4, which will be omitted hereinafter.

In the embodiment of the disclosure, a multicolor filter capable of filtering multiple light colors is additionally provided to the binocular camera, and the color changing of the multicolor filter is controlled, such that the binocular camera may recognize multiple game guns with different colors of light sources by the multicolor filter, so as to determine homing positions of more game guns on the display screen, thus the accuracy of determining the homing positions is improved, the number of the game guns participating in a game is increased, and that a plurality of game guns to be simultaneously used in the game are supported by only one set of binocular camera is realized.

An embodiment of the disclosure application provides a nonvolatile computer storage media having computer executable instructions stored thereon, wherein the computer executable instructions can perform any one of the methods for determining a homing position of a game gun on a display screen in the foregoing embodiments of methods.

FIG. 6 is a schematic diagram of a structure of an hardware of the electronic device of the method for determining a homing position of a game gun on a display screen according to a fifth embodiment of the disclosure. As shown in FIG. 6, this device includes:

one or more processors 610 and a memory 620, in FIG. 6, one memory 610 is employed as an example.

The electronic device of the method for the methods for determining a homing position of a game gun on a display screen may further comprise: an input apparatus 630 and an output apparatus 640.

The processor 610, the memory 620, the input apparatus 630 and the output apparatus 640 may be connected via a bus or other means, in FIG. 6, a connection via a bus is taken as an example.

As a nonvolatile computer readable storage media, the memory 620 can be used to store nonvolatile software program, nonvolatile computer executable program and module, such as the program instructions/modules corresponding to the method for alleviating light leakage of a monitor in the embodiments of the present application (e.g., the color switching module 401, the image acquiring module 402, the first determining module 403 and the second determining module 404 as shown in FIG. 4). The processor 610 executes various functions and applications of a server and data processing by running a nonvolatile software program, instructions and a module stored in the memory 620, so as to carry out the processing method for determining a homing position of a game gun on a display screen in the embodiments above.

The memory 620 may include a program storage area and a data storage area, wherein the program storage area can store an operating system, an application program required for at least one function; the data storage area can store the data created based on the use of the apparatus for alleviating light leakage of a monitor, or the like. Further, the memory 620 may include high-speed random access memory, and may further include nonvolatile memory, such as at least one disk storage device, flash memory device, or other nonvolatile solid-state memory devices. In some embodiments, the memory 620 optionally includes a memory remotely located with respect to the processor 610, which may be connected to an apparatus for alleviating light leakage of a monitor via a network. Examples of such network include, but not limited to, Internet, Intranet, local area network (LAN), mobile communication network, and combinations thereof.

The input apparatus 630 may receive the input numbers or characters information, as well as key signal input associated with user settings of the apparatus for alleviating light leakage of a monitor and function control. The output apparatus 440 may include a display screen or other display device.

The one or more modules are stored in the memory 620, and when being executed by the one or more processors 610, execute the method for alleviating light leakage of a monitor according to the above embodiments of method.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present application may have many forms, for example, including, but not limited to:

(1) mobile communication device: the characteristic of such device is: it has the function of mobile communication, and takes providing voice and data communications as the main target. Such type of terminal includes: smart phones (for example iPhone), multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices.

(3) portable entertainment device: this type of device can display and play multimedia content. Such type of device includes: audio players (for example iPod), video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

An embodiment of the disclosure provides an apparatus for determining a homing position of a game gun on a display screen, including one or more processors;

a memory;

one or more programs, wherein the one or more programs are stored in the memory, and when being executed by the one or more processors, execute:

when detecting that a binocular camera accesses, controlling a multicolor filter in the binocular camera to change colors in accordance with a preset switching rule, and controlling the binocular camera to acquire images of different colors of light spots on a screen of a display screen through the multicolor filter in a time-sharing manner, wherein different colors of the light spots are emitted by different game guns; determining identifier information of a plurality of current game guns corresponding to the light spots in the acquired images according to preset colors and shapes of the light spots of the game guns; and determining homing positions of the plurality of current game guns on the screen according to the acquired images of the light spots and a preset positioning algorithm.

Details, which are not described in detail, of the embodiments of the disclosure refer to the description of the previously-described embodiments.

In multiple embodiments provided by this application, it is to be understood that the disclosed system, apparatus and method may be implemented in other forms. For example, the apparatus embodiments described as above are merely schematic. For example, the partitioning of the module is merely one kind of logic functional partitioning. There may be other partitioning manners in actual implementation, for example, multiple modules or components may be combined or integrated into another system, or some features may be ignored or not executed. Moreover, the displayed or discussed mutual coupling or direct coupling or communication connection therebetween may be indirect coupling or communication connection through some interfaces, apparatuses or modules, and may be of an electrical form, a mechanical form or other forms.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A method for determining a homing position of a game gun on a display screen, which is applied to a display of a smart device, comprising:
when detecting that a binocular camera accesses, controlling a multicolor filter in the binocular camera to change colors in accordance with a preset switching rule, and controlling the binocular camera to acquire images of different colors of light spots on a screen of a display screen through the multicolor filter in a time-sharing manner, wherein different colors of the light spots are emitted by different game guns;
determining identifier information of a plurality of current game guns corresponding to the light spots in the acquired images according to preset colors and shapes of the light spots of the game guns; and
determining homing positions of the plurality of current game guns on the screen according to the acquired images of the light spots and a preset positioning algorithm.

2. The method according to claim 1, wherein: after the determining identifier information of a plurality of current game guns corresponding to the light spots in the acquired images, the method further comprising:
re-selecting a switching rule used for controlling color changing of the multicolor filter in the binocular camera according to the number of the plurality of current game guns;
then the controlling a multicolor filter in the binocular camera to change colors in accordance with a preset switching rule comprises:
controlling color changing of the multicolor filter in the binocular camera according to the re-selected switching rule.

3. The method according to claim 2, wherein: before the re-selecting a switching rule used for controlling color changing of the multicolor filter in the binocular camera according to the number of the plurality of current game guns, the method further comprising:
determining whether the number of the plurality of current game guns is less than that of colors changed by the multicolor filter specified in the switching rule;
if yes, executing the step of re-selecting a switching rule used for controlling color changing of the multicolor filter in the binocular camera according to the number of the plurality of current game guns; and
if not, executing a step of respectively determining homing positions of the plurality of current game guns on the screen according to parameters of the binocular camera, a screen display parameter of the screen, a color filtering order specified in the switching rule as well as position information between the camera and the plurality of current game guns.

4. The method according to claim 1, wherein the determining homing positions of the plurality of current game guns on the screen according to the acquired images of the light spots and a preset positioning algorithm comprises:
respectively obtaining distances between the plurality of current game guns and the screen as well as orientations of the plurality of current game guns by using a binocular distance measuring principle through a preset image recognition algorithm according to the acquired images of the light spots as well as a center distance and focal lengths of the binocular camera; and
obtaining a display size of the screen by the binocular camera, and calculating coordinates of the homing positions of the plurality of current game guns on the screen according to the distances between the plurality of current game guns and the screen as well as the orientations of the plurality of game guns.

5. The method according to claim 1, wherein the determining identifier information of a plurality of current game guns corresponding to the light spots in the acquired images according to preset colors and shapes of the light spots of the game guns comprises:
determining identifier information of a plurality of current game guns corresponding to the light spots in the acquired images according to preset colors and shapes of the light spots of the game guns as well as the number of the light spots.

6. An electronic device for determining a homing position of a game gun on a display screen, comprising:
one or more processors; and
a memory; wherein,
the memory is stored with instructions executable by the one or more processors, the instructions are configured to:
when detecting that a binocular camera accesses, control a multicolor filter in the binocular camera to change colors in accordance with a preset switching rule, and control the binocular camera to acquire images of different colors of light spots on a screen of a display screen through the multicolor filter in a time-sharing manner, wherein different colors of the light spots are emitted by different game guns;
determine identifier information of a plurality of current game guns corresponding to the light spots in the acquired images according to preset colors and shapes of the light spots of the game guns; and
determine homing positions of the plurality of current game guns on the screen according to the acquired images of the light spots and a preset positioning algorithm.

7. The electronic device according to claim 6, wherein: after the determine identifier information of a plurality of current game guns corresponding to the light spots in the acquired images, the electronic device further comprising:
re-select a switching rule used for controlling color changing of the multicolor filter in the binocular camera according to the number of the plurality of current game guns;
then the control a multicolor filter in the binocular camera to change colors in accordance with a preset switching rule comprises:
control color changing of the multicolor filter in the binocular camera according to the re-selected switching rule.

8. The electronic device according to claim 7, wherein: before the re-select a switching rule used for controlling color changing of the multicolor filter in the binocular camera according to the number of the plurality of current game guns, the electronic device further comprising:
determine whether the number of the plurality of current game guns is less than that of colors changed by the multicolor filter specified in the switching rule;
if yes, execute the step of re-select a switching rule used for controlling color changing of the multicolor filter in the binocular camera according to the number of the plurality of current game guns; and
if not, execute a step of respectively determine homing positions of the plurality of current game guns on the screen according to parameters of the binocular camera, a screen display parameter of the screen, a color filtering order specified in the switching rule as well as position information between the camera and the plurality of current game guns.

9. The electronic device according to claim 6, wherein the determine homing positions of the plurality of current game guns on the screen according to the acquired images of the light spots and a preset positioning algorithm comprises:
respectively obtain distances between the plurality of current game guns and the screen as well as orientations of the plurality of current game guns by using a binocular distance measuring principle through a preset image recognition algorithm according to the acquired images of the light spots as well as a center distance and focal lengths of the binocular camera; and
obtain a display size of the screen by the binocular camera, and calculating coordinates of the homing positions of the plurality of current game guns on the screen according to the distances between the plurality of current game guns and the screen as well as the orientations of the plurality of game guns.

10. The electronic device according to claim 6, wherein the determine identifier information of a plurality of current game guns corresponding to the light spots in the acquired images according to preset colors and shapes of the light spots of the game guns comprises:
determine identifier information of a plurality of current game guns corresponding to the light spots in the acquired images according to preset colors and shapes of the light spots of the game guns as well as the number of the light spots.

11. A nonvolatile computer storage media, which has computer executable instructions stored thereon, wherein the computer executable instructions are configured to:
when detecting that a binocular camera accesses, control a multicolor filter in the binocular camera to change colors in accordance with a preset switching rule, and control the binocular camera to acquire images of different colors of light spots on a screen of a display screen through the multicolor filter in a time-sharing manner, wherein different colors of the light spots are emitted by different game guns;
determine identifier information of a plurality of current game guns corresponding to the light spots in the acquired images according to preset colors and shapes of the light spots of the game guns; and
determine homing positions of the plurality of current game guns on the screen according to the acquired images of the light spots and a preset positioning algorithm.

12. The nonvolatile computer storage media according to claim 11, wherein: after the determine identifier information of a plurality of current game guns corresponding to the light spots in the acquired images, the nonvolatile computer storage media further comprising:
re-select a switching rule used for controlling color changing of the multicolor filter in the binocular camera according to the number of the plurality of current game guns;
then the control a multicolor filter in the binocular camera to change colors in accordance with a preset switching rule comprises:
control color changing of the multicolor filter in the binocular camera according to the re-selected switching rule.

13. The nonvolatile computer storage media according to claim 12, wherein: before the re-select a switching rule used for controlling color changing of the multicolor filter in the binocular camera according to the number of the plurality of current game guns, the nonvolatile computer storage media further comprising:
determine whether the number of the plurality of current game guns is less than that of colors changed by the multicolor filter specified in the switching rule;
if yes, execute the step of re-select a switching rule used for controlling color changing of the multicolor filter in the binocular camera according to the number of the plurality of current game guns; and
if not, execute a step of respectively determine homing positions of the plurality of current game guns on the screen according to parameters of the binocular camera, a screen display parameter of the screen, a color filtering order specified in the switching rule as well as position information between the camera and the plurality of current game guns.

14. The nonvolatile computer storage media according to claim 11, wherein the determine homing positions of the plurality of current game guns on the screen according to the acquired images of the light spots and a preset positioning algorithm comprises:
respectively obtain distances between the plurality of current game guns and the screen as well as orientations of the plurality of current game guns by using a binocular distance measuring principle through a preset image recognition algorithm according to the acquired images of the light spots as well as a center distance and focal lengths of the binocular camera; and
obtain a display size of the screen by the binocular camera, and calculating coordinates of the homing positions of the plurality of current game guns on the screen according to the distances between the plurality of current game guns and the screen as well as the orientations of the plurality of game guns.

15. The nonvolatile computer storage media according to claim 11, wherein the determine identifier information of a plurality of current game guns corresponding to the light spots in the acquired images according to preset colors and shapes of the light spots of the game guns comprises:
determine identifier information of a plurality of current game guns corresponding to the light spots in the acquired images according to preset colors and shapes of the light spots of the game guns as well as the number of the light spots.
